(19) United States
(12) Patent Application Publication
(10) Pub. No.: US 2026/0149101 A1
(43) Pub. Date: May 28, 2026

(54) BATTERY MODULE AND BATTERY PACK

(71) Applicant: Avant Tecno Oy, Ylöjärvi (FI)

(72) Inventors: Santtu TYYNELÄ, Ylöjärvi (FI); Mikko PIEPPONEN, Ylöjärvi (FI)

(21) Appl. No.: 19/122,552

(22) PCT Filed: Sep. 20, 2023
(86) PCT No.: PCT/FI2023/050535

§ 371 Date: Apr. 18, 2025

(30) Foreign Application Priority Data
Oct. 21, 2022 (FI) 20225954

(51) Int. Cl. H01M 50/242; B60L 50/64; B60L 58/12; H01M 10/615; H01M 10/625; H01M 10/643; H01M 10/6568; H01M 50/213; H01M 50/227; H01M 50/249; H01M 50/291

(52) U.S. Cl. CPC H01M 50/242; B60L 50/64; B60L 58/12; H01M 10/615; H01M 10/625; H01M 10/643; H01M 10/6568; H01M 50/213; H01M 50/227; H01M 50/249; H01M 50/291; H01M 2220/20

(57) ABSTRACT

A battery module (100) comprising a plurality of battery cells (110), a busbar assembly (120) configured to electrically couple the battery cells (110), a housing (130) having an inner space (132), and the plurality of battery cells (120) being arranged in the inner space (132), a plurality of recesses (140) in the inner space (132) of the housing (130), the battery cells (110) being arranged towards the recesses (140), wherein the recess (140) has rotationally asymmetric shape relative to a central axis (116) of the corresponding battery cell (110), and a filler (150) arranged in the recess (140) and attached to the battery cell (110), whereby the recess (140) prevents the filler (150) and the battery cell (110) being rotated by the rotationally asymmetric shape of the recess (140).

### FIELD OF THE INVENTION

The invention relates to a field of batteries, especially to modular battery modules for forming battery packs.

### BACKGROUND OF THE INVENTION

Different kind of battery packs are widely used in electric vehicles. There is a plurality of modular battery modules available in the market that can be used to form a desired battery pack.

A drawback with the battery modules of prior art is a structure of the battery modules which may provide limitations for components used therein.

### BRIEF DESCRIPTION OF THE INVENTION

An object of the present invention is to provide a novel battery module and battery pack.

The invention is characterized by the features of the independent claims.

The invention is based on the idea of a battery module comprising a plurality of battery cells, a busbar assembly, a housing having an inner space, rotationally asymmetric recesses in the inner space of the housing and a filler in the recess, wherein the filler is attached to the battery cell for preventing a rotation of the battery cells by the rotationally asymmetric shape of the recess.

An advantage of the solution is the filler preventing the rotation of the battery cells by the rotationally asymmetric shape of the recess.

Some embodiments of the invention are disclosed in the dependent claims.

### BRIEF DESCRIPTION OF THE DRAWINGS

In the following the invention will be described in greater detail by means of preferred embodiments with reference to the accompanying drawings, in which

FIG. 1A shows schematically and partially a battery module in a cross-sectional view as seen from a side of the battery module,

FIG. 1B shows schematically a detail of the battery module of FIG. 1A as seen from above of the battery module,

FIG. 1C shows schematically a battery cell of the battery module of FIG. 1A as seen obliquely from above the battery cell,

FIG. 2 shows schematically a section of a lower housing and the battery cells of the battery module of FIG. 1A as seen obliquely from above the battery module,

FIG. 3 shows schematically a heat unit and the battery module of FIG. 1A in a cross-sectional view as seen from above of the battery module,

FIG. 4 shows schematically a battery pack as seen from a side of the battery pack,

FIG. 5 shows schematically a battery pack of FIG. 4 with a protective casing and a control unit as seen in a cross-sectional view from a side of the battery pack, and

FIG. 6 shows schematically and partially a battery module of FIG. 1A with recesses locating below the battery cells and between the battery cells.

For reasons of clarity, some embodiments of the invention are illustrated in the figures in a simplified form. In the figures, like reference numerals identify like elements.

### DETAILED DESCRIPTION OF THE INVENTION

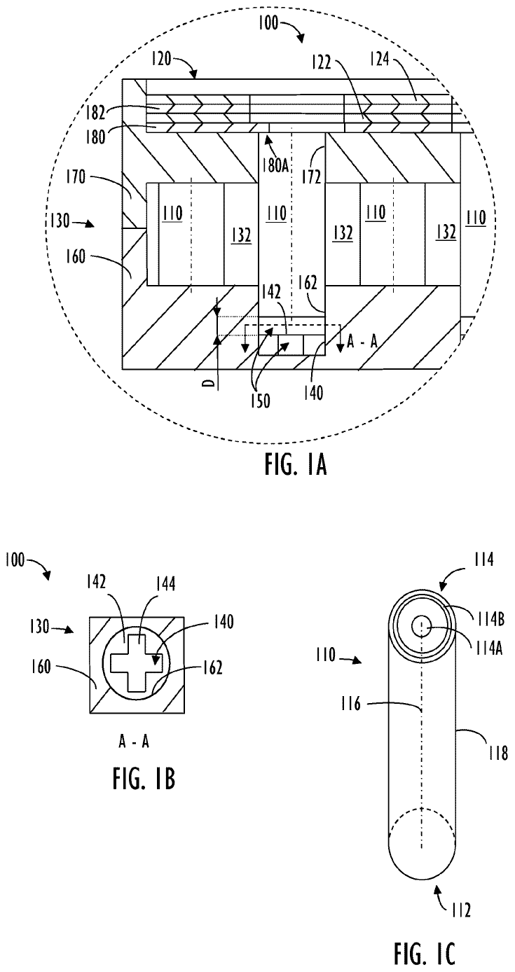

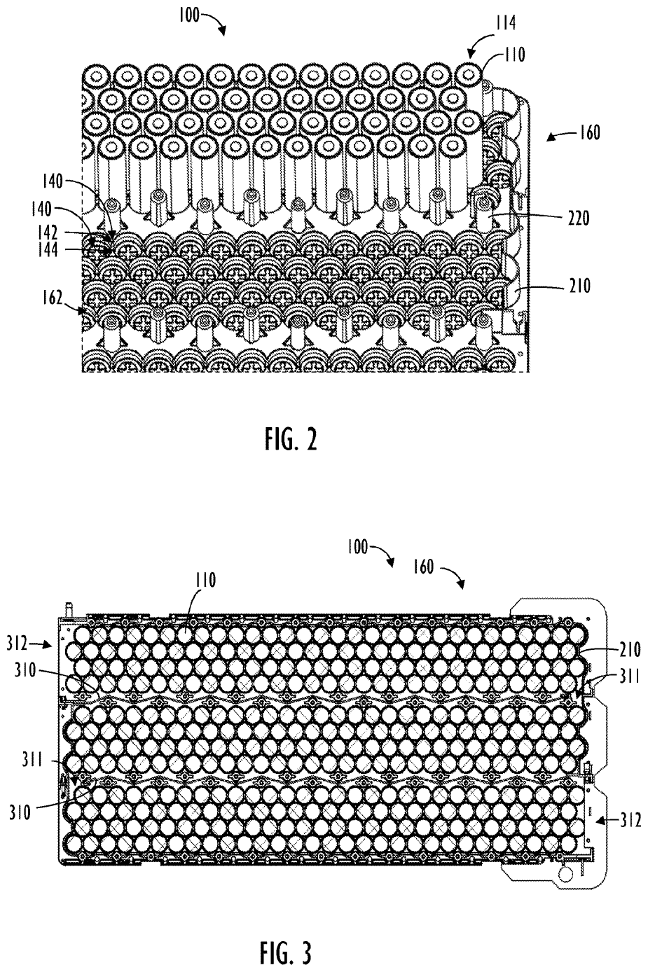

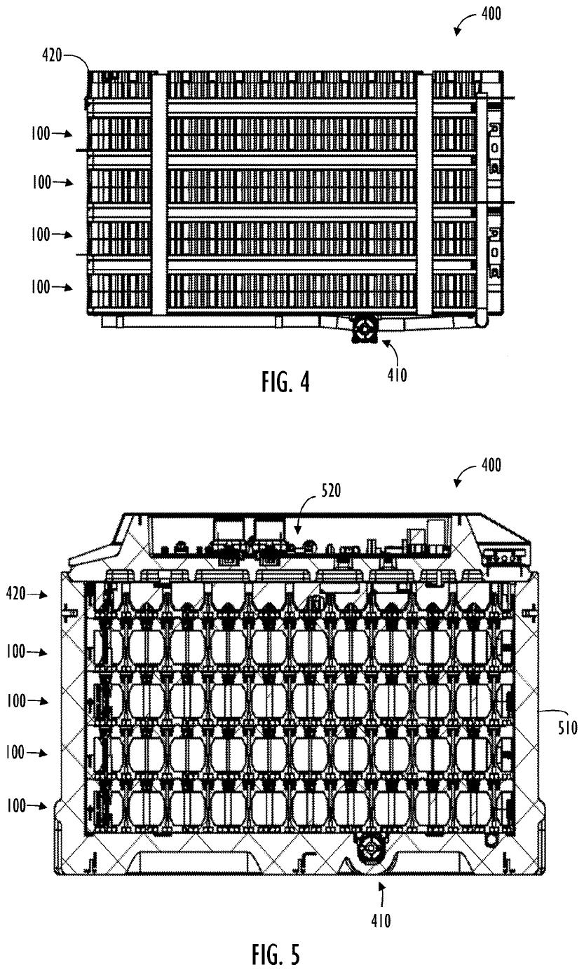

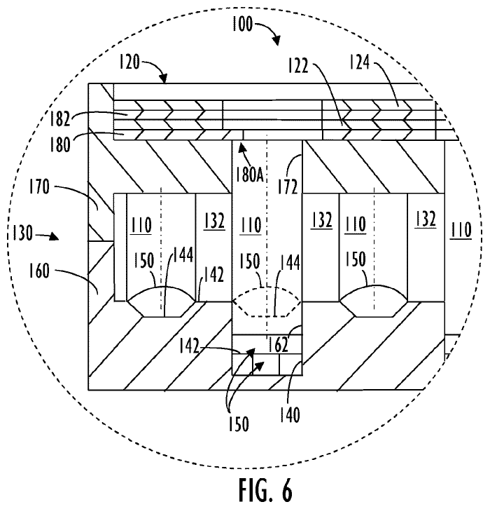

FIG. 1A shows schematically parts of a battery module 100, such as a plurality of battery cells 110, a busbar assembly 120, a housing 130, a recess 140 and a filler 150 for example, in a cross-sectional view as seen from a side of the battery module 100. FIG. 1B shows schematically a detail of the recess of the battery module 100 of FIG. 1A from above of the battery module 100. FIG. 1C shows schematically a battery cell of the battery module 100 of FIG. 1A as seen obliquely from above the battery cell. FIG. 2 shows schematically a section of a lower housing and battery cells of the battery module 100 of FIG. 1A as seen obliquely from above the battery module 100. FIG. 3 shows schematically a heat unit and the battery module of FIG. 1A in a cross-sectional view as seen from above of the battery module 100. FIG. 4 shows schematically a battery pack as seen from a side of the battery pack. FIG. 5 shows schematically a battery pack of FIG. 4 with a protective casing 510 and a control unit 520 as seen in a cross-sectional view from a side of the battery pack. FIG. 6 shows schematically and partially a battery module of FIG. 1A with recesses 140 locating below the battery cells 110 and between the battery cells 110.

The battery module 100 of the Figures comprises a plurality of battery cells 110. The battery cells 110 are typically cylindrical, i.e., having a shape of a round bar. Each battery cell 110 has a first end 112, a second end 114, and a central axis 116 between the first end 112 and the second end 114. The battery cell 110 is typically rotationally symmetric relative to the said central axis 116. The battery cell 110 is preferably a Lithium ion (Li-ion) battery. The battery cell 110 may also be other kind of battery such as a nickel-metal hydride (Ni—MH) battery, for example. The battery cell 110 has a side portion 118 between the first end 112 and the second end 114 of the battery cell 110, which is illustrated for example in FIG. 1C. The battery cell 110 is typically surrounded at least partly by a metallic surface for protecting the battery cell. Also, the said metallic surface of the battery cell is configured for being attached to a filler, which filler is disclosed in more detail below.

The battery cell 110 of the Figures further has terminals to be coupled electrically. The second end 114 of the battery cell 110 comprises a positive terminal 114A at a centre of the said second end 114, and a negative terminal 114B around the positive terminal 114A at a certain distance, which terminals are illustrated in FIG. 1C for example. The first end 112 of the battery cell 110 may comprise a negative terminal, but it is not necessary for the electrical connection herein. Thus, the electrical coupling is possible to be arranged, for example, by using the second end 114 of the battery cell 110 without using the first end 112 of the battery cell 110.

The battery module 100 of the Figures comprises a busbar assembly 120 configured to electrically couple the battery cells 110. The battery cells 110 may be connected in series and in parallel for achieving a required voltage and capacity. The busbar assembly 120 comprises at least one lower busbar 122 in vicinity of the second end 114 of the battery cells 110, wherein the positive terminals 114A of the determined battery cells 110 are coupled to the at least one lower bus-bar 122. The busbar assembly 120 comprises at least one upper busbar 124 in vicinity of the second end 114 of the battery cells 110, and in vicinity of the at least one lower busbar 122, wherein the negative terminals 114B of the determined battery cells 110 are coupled to the at least one upper busbar 124. The at least one lower busbar 122 and the at least one upper busbar 124 are configured to electrically couple the battery cells 110 together to form the desired battery cell configuration having the desired voltage and capacity. The electric coupling between the said positive terminal 114A and the at least one lower busbar 122 is made for example via bonded wires, and respectively between the said negative terminal 114B and the at least one upper busbar 124, which bonded wires are not illustrated in the Figures for sake of the clarity. The said busbars may be plate-like parts made of conductive material. The said busbar assembly 120 is attached or coupled to a housing 130 such as to an upper housing 170 for example, the said busbar assembly 120 locating above the housing 130, wherein the housing 130 and the upper housing 170 are disclosed in more detail below.

The battery module 100 of the Figures comprises a first non-conductive part 180 between the battery cells 110 and the at least one lower busbar 122 for preventing unwanted electric couplings. The first non-conductive part 180 is for example a plastic plate comprising a plurality of openings in an area of the second ends 114 of the battery cells 110 for the openings allowing the electric coupling of the battery cells 110 to be made. The battery module 100 comprises also a second non-conductive part 182 such as a plastic plate between the at least one lower bus-bar 122 and the at least one upper busbar 124 for preventing the said unwanted electric couplings.

The first non-conductive part 180 further comprises a limiter 180A illustrated in FIG. 1A. The limiter 180A locates partly against the second end 114 of the battery cells 110 for limiting a movement of the battery cells 110 in the direction of the central axis 116 of the corresponding battery cells.

The battery module 100 of the Figures comprises a housing 130 having an inner space 132 for the plurality of the battery cells 110 being arranged therein. The battery cells 110 are arranged in the inner space 132 of the housing 130, wherein the battery cells 110 are in a certain pattern, for example, the second end 114 of each battery cell 110 being on a same height in the housing, and against the limiter 180A of the first non-conductive part 180, which obtained same height is disclosed in more detail below. The housing 130 limits the battery cells 110 being moved in a lateral direction of the battery cells 110 and in a direction of the central axis 116 of the battery cells 110. The housing 130 and/or its parts are made of plastic, which has advantages in manufacturing, manufacturing costs, and which provides more light-weight structure compared to metallic structures.

The battery module 100 of the Figures comprises a plurality of recesses 140 in the housing 130 for the first end 112 and/or the central axis 116 of the battery cells 110 being arranged towards the said recesses 140, i.e., the battery module 100 comprises a plurality of first bottoms 142 and second bottoms 144 below each corresponding first bottoms 142, the said bottoms locating in the housing 130 for the first end 112 of the battery cells 110 being arranged towards the said first and second bottoms. The plurality of recesses 140 locate in the inner space of the housing 130, wherein in the recesses 140 there is a space for being filled by a filler 150, i.e., in the inner space of the housing 130 there is a plurality of first bottoms 142 and a plurality of second bottoms 144, wherein there is a space between the first bottom 142 and the second bottom 144 for being filled by the filler 150. The said space for being filled is thus intended for receiving a filler 150, which filler 150 is disclosed in more detail below. Each recess 140 has a rotationally asymmetric shape relative to the central axis 116 of the corresponding battery cell 110, i.e., each space between the first bottom 142 and the second bottom 144 has rotationally asymmetric shape relative to the central axis 113 of the corresponding battery cell 112. The shape of the recess 140 may be for example a cross, square, hex or polygon, i.e., the shape of the space between the first bottom 142 and the second bottom 144 may be for example a cross, square, hex or polygon. The shape of the recess 140 may also comprise an extrusion between the recess in the depth direction of the recess 140, i.e., the shape of the space between the first bottom 142 and the second bottom 144 may comprise an extrusion in the depth direction of the said bottoms for example. The shape of the recess 140 may also be cylindrical if it is rotationally asymmetric relative to the central axis 116 of the corresponding battery cell 110, for example.

The battery module 100 of the Figures comprises a plurality of recesses 140 in the housing 130 for the side portion 118 of the battery cells 110 being arranged towards said recesses 140, i.e., the battery module 100 comprises a plurality of first bottoms 142 and second bottoms 144 below each corresponding first bottoms 142, said bottoms locating in the housing 130 for the side portion 118 of the battery cells 110 being arranged towards said first and second bottoms. The plurality of recesses 140 locate at the side portion 118 of the battery cells 110. The plurality of recesses 140 locate between the battery cells 110. Said recesses 140 locate in the inner space 132 of the housing 130, wherein in the recesses 140 there is a space for being filled by the filler 150, i.e., in the inner space of the housing 130 there is a plurality of first bottoms 142 and a plurality of second bottoms 144, wherein there is a space between the first bottom 142 and the second bottom 144 for being filled by the filler 150. Said recess 140 has a rotationally asymmetric shape relative to the central axis 116 of the corresponding battery cell(s) 110.

For sake of the clarity, said recesses 140 are arranged below the battery cells 110 and/or between the battery cells 110. Thus, the recess 140 locates below the corresponding battery cell 110 and/or between the corresponding battery cells 110. The first end 112 and/or the central axis 116 of the battery cells 110 is towards the recess 140, or alternatively or in addition, the side portion 118 of the battery cells 110 is towards the recess 140.

The battery module 100 of the Figures comprises a filler 150 in the said space of the recesses for the filler 150 being attached to the battery cells 110, i.e., the battery module comprises a filler 150 in the said space between the first bottom 142 and the second bottom 144 for the filler 150 being attached to the battery cells 110. The filler 150 is an adhesive configured to adhere onto the surroundings and especially to the metallic surface of the battery cell 110, wherein the adhesive hardens in a certain time. Before the battery cells 110 are inserted towards the recesses 140, the filler 150 is inserted into each recess 140, i.e., the filler is inserted into the space between the first bottom 142 and the second bottom 144. A volume of the filler 150 is greater than a volume of the space of the recess 140, i.e., a volume of the space between the first bottom 142 and the second bottom 144. Therefore, there is a distance D between the first end 112 of the battery cell 100 and the recess 140, i.e., the first bottom 142. For achieving a durable attachment between the filler 150 and the battery cell 110, the battery cell 110 is being pressed against the filler 150 in an installation phase, whereby the filler 150 spreads essentially to the space of the recess 140 and against the battery cell 110. The recess 140 prevents the filler 150 and the battery cell 110 being rotated by the shape of the recess 140, i.e., the shape between the first bottom 142 and the second bottom 144 prevents the filler 150 and the battery cell 110 being rotated, both in cases, wherein the filler 150 is attached to or detached from the surroundings such as the recess 140 or the housing 130.

Thus, even if the filler 150 is not attached to the housing 130 or to the recess 140, the shape of recess 140 physically prevents the rotation of the battery cell 110 that is attached to the filler 150. The said rotation of the battery cell 110, wherein the said rotation is caused by forces such as hits and vibrations directed towards the battery module 100, must be prevented because the said rotation breaks the electrical connection between the said busbars and the battery cells 110 for example by breaking the above-mentioned bonded wires. The filler 150 typically get attached to the recess 140 or to other surroundings, but, however, the attachment between the filler 150 and the recess 140 may become destroyed because of forces such as hits and vibrations directed towards the battery module 100 and its structures. Also, the shape of the recess 140 preventing rotations of the battery cells 110 reduces requirements for properties of the filler 150.

For sake of the clarity, the filler 150 is attached to the first end 112 of the battery cell 110 and/or to the side portion 118 of the battery cell 110. The filler 150 can be attached between two adjacent battery cells 110 for fixing said two adjacent battery cells 110 relative to each other.

The housing 130 of the Figures further comprises a lower housing 160 for supporting the side portion 118 of each battery cell 110 nearby the first end 112 of each battery cell 110. The lower housing 160 has a plurality of sockets 162 in the inner space 132 of the housing 130, the first end 112 of each battery cell 110 being set in the said corresponding socket 162. A wall of the socket 162 is against the side portion 118 of the battery cell 110 with a certain tolerance substantially preventing the lateral movement of the battery cell 110. The above-mentioned recesses 140 locate in the bottom of the sockets 162, i.e., the above-mentioned first bottoms 142 in the housing 130 locate in the bottom of the sockets 162, wherein the second bottoms 144 locate below the first bottoms 142. FIG. 1B schematically shows that the socket 162 has a common surface with the recess 140, wherein the common surface is the said first bottom 142. Further, the lower housing has the recesses 140 locating at the wall of the sockets 162, whereby the side portion 118 of the battery cell 110 is towards the recess 140, which can be seen in FIG. 2, for example. Each recess 140 at wall of the sockets 162 extends between two adjacent sockets 162. For sake of the clarity, the recesses 140 can locate at the bottom of the sockets 162 and/or at the wall of the sockets 162.

Further, the lower housing 160 has walls 210 that surrounds the battery cells 110 for protecting the battery cells 110 and for providing partially the inner space 132 of the housing 130.

The battery module 100 of the Figures further comprises an upper housing 170, wherein the upper housing 170 has walls adapting to the walls 210 of the lower housing 160 to form the inner space 132 of the housing 130 for the battery cells 110. The lower housing 160 and the upper housing 170 comprises mountings 220 for attaching the lower housing 160 and the upper housing 170 to each other, the attachment being made by screws, for example.

Further, the upper housing 170 of the Figures is supporting the side portion 118 of each battery cell 110 nearby the second end 114 of each battery cell 110. The upper housing 170 has a plurality of sockets 172, the second end 116 of each battery cell 110 being in the said corresponding socket 172. A wall of the socket 172 is against the side portion 118 of the battery cell 110 with a certain tolerance substantially preventing the lateral movement of the battery cell 110.

According to an embodiment, instead of the limiters 180A of the first non-conductive part 180, the upper housing 170 has limiters for preventing the movement in direction of the central axis 116 of the corresponding battery cell 110, which limiters of the upper housing 170 are not illustrated in the Figures. The limiters may be integrated into the upper housing 170 or they may be removably attachable to the upper housing 170 by mountings, wherein the mountings are screws, for example.

In the installation phase, the limiter 180A of the non-conductive part 180 presses the battery cell 110 into the socket 162 of the lower housing 160 against the filler 150 before the filler 150 is being hardened, wherein the filler 150 works partially as a spring due to its physical properties, whereby the filler 150 partially push the battery cell 110 against the limiter 180A of the first non-conductive part 180. Therefore, there is no gap in the direction of the central axis 116 of the battery cells 110 for the battery cells 110 in the inner space 132 of the housing 130, because the filler 150 eliminates the gap in the direction of the said central axis 116 of the battery cell 110, which provides advantageous manufacturing tolerances of the housing 130 to be used. According to an embodiment, the limiters of the upper housing 170 presses the battery cells 110 into the sockets 162 of the lower housing 160 against the fillers 150.

The inner space 132 of the housing 130 of the battery module 100 of the Figures is configured to be filled with a first heat transfer liquid for balancing a heat between the battery cells 110 and the first heat transfer liquid, wherein the first heat transfer liquid heats or cools the battery cells 110 or maintains the temperature thereof. The battery module 100 comprises a first heat transfer liquid filled into the inner space 132 of the housing 130, which first heat transfer liquid is not illustrated in the Figures for sake of the clarity. The first heat transfer liquid is essentially in connect with the side portion 118 of the battery cells 110, i.e., the battery cells 110 are mostly surrounded by the first heat transfer liquid. There are gaps between the battery cells 110 in the lateral direction of the battery cells 110 allowing the first heat transfer liquid to locate in the gaps, whereby the heat is transferred effectively between the battery cells 110 and the first heat transfer liquid.

Further, said wall of the socket 172 of the upper housing 170 against the side portion 118 of the battery cell 110 also prevents the first heat transfer liquid to flow via between the wall of the socket 172 and the side portion 118 of the battery cell 110 to a space, wherein the busbar assembly 120 locates. Respectively, said limiter 180A prevents the first heat transfer liquid to flow via between the battery cell 110 and the limiter 180A to the space, wherein the busbar assembly 120 locates. Also, the said wall of the socket 172 of the upper housing 170 against the side portion 118 of the battery cell 110 also prevents a second heat transfer liquid to flow via between the wall of the socket 172 and the side portion 118 of the battery cell 110 to the inner space 132 of the battery module 100, which second heat transfer liquid is disclosed in more detail below.

The battery module 100 comprises at least one heat unit 310 for heating the first heat transfer liquid that heats the battery cells 110. For example, as illustrated in FIG. 3, the battery module 100 comprises two heat units 310 in the inner space 132 of the housing 130. The heat unit 310 locates in the inner space of the housing 130 between determined battery cells 110. The heat unit 310 comprises an elongated plate and electric wires for heating the elongated plate inside the elongated plate, wherein the electric wires are configured to be in an electric connection. The elongated plate may be flexible or rigid, for example.

The battery pack 400 of FIGS. 4 and 5 comprises four battery modules 100, wherein a quantity of the battery modules 100 affects to the capacity of the battery pack. The battery pack may comprise one, two, three, four or more battery modules 100, for example. The voltage of the battery pack may be 44 V, for example. The quantity of the battery modules 100 determines the capacity of the battery pack, which may be ˜7 kWh, ˜13 kWh, ˜21 kWh or ˜27 kWh, for example. The voltage and the capacity of the battery pack may vary depending on an embodiment of the battery module 100.

Further, the battery modules 100 of the battery pack 400 are arranged one on the other, whereby the busbar assemblies 120 locates between the adjacent battery modules 100 excluding the busbar assembly 120 of a topmost battery module 100. There are openings between the adjacent battery modules 100 for allowing a second heat transfer liquid to surround the busbar assemblies 120, which second heat transfer liquid is disclosed in more detail below.

Further, the battery pack 400 comprises a cover unit 420 on the top-most battery module 100 for safety reasons. There are openings between the top-most battery module 100 and the cover unit 420 for allowing the second heat transfer liquid to surround the busbar assembly 120 of the topmost battery module 100, which second heat transfer liquid is disclosed in more detail below. The cover unit 420 has a space for being filled by the second heat transfer liquid. The cover unit 420 may comprise a fire protection plate for preventing fire to spread in cases of battery cell(s) 110 causing fire.

The battery pack 400 of FIGS. 4 and 5 comprises a pump 410 for circulating the first heat transfer liquid through the inner space 132 of the housing 130 of the battery module(s) 100 via a closed loop. The housing 130 of the battery module 100 comprises two connecting ports 312 for being coupled to the pump 410 and/or to the adjacent battery module(s) 100, which is implemented by couplings such as hoses, pipes, or integrated connecting structures with gaskets, for example. The inner space 132 of the battery modules 100 are coupled via the said connecting ports 312 to the inner space 132 of adjacent battery module(s) 100 and/or the pump, providing the closed loop thereby. For example, if the battery pack 400 comprises four battery modules 100 as illustrated in FIGS. 4 and 5, the connecting ports 312 of the first battery module 100 are coupled to the pump 410 and to the connecting port 312 of the second battery module 100, the connecting ports 312 of the second battery module 100 are coupled to the connecting ports 312 of the first battery module 100 and the third battery module 100, the connecting ports 312 of the third battery module 100 are coupled to the second battery module 100 and the fourth battery module 100, and the connecting ports 312 of the fourth battery module 100 are coupled to the third battery module 100 and to the pump 410.

Further, the above-mentioned elongated plate(s) of the heat unit 310 and the walls of the housing 130 forms a slalom path in the inner space 132 of the housing 130 of the battery module 100, providing a guided path for the first heat transfer liquid when circulated through the said inner space 132 via the said connecting ports 312. To form the said slalom path by the elongated plate(s) of the heat unit 310, there is a gap 311 between an end of the elongated plate of each heat unit 310 and the walls of the housing 130, wherein the said gap 311 allows the first heat transfer liquid to be flowed through. A purpose of the slalom path is to provide that all the first heat transfer liquid circulates via the pump 410, thus, there are no areas in the inner space 132 of the housing 130, wherein the first heat transfer liquid stays still for example. According to an embodiment, the slalom path in the inner space 132 of the housing 130 may be formed by the additional wall structures of the housing 130, thus without wall of the heat unit 310.

Also, the above-mentioned gaps between the battery cells 110 in the lateral direction of the battery cells 110, providing the essential surface of the side portion of each battery cell 110 to be in contact with the first heat transfer liquid, also provides the first heat transfer liquid to flow in the gaps and through the gaps, whereby the first heat transfer liquid is configured to be circulated efficiently through the inner space 132 of the housing 130 via each battery cell 110.

Further, the slalom path in the inner space 132 of the housing 130 ensures that the first heat transfer liquid circulates essentially via all the battery cells 110 for the heat exchange between the battery cells 110 and the first heat transfer liquid.

The battery pack 400 of FIG. 5 comprises a control unit 520 for controlling operations of the battery pack, wherein the control unit 520 is connected to the battery modules 100. The battery pack 400 comprises an output for connecting the battery modules 100 to an electric vehicle such as a work machine or a car, for example. The control unit 520 controls and measures for example the current and the voltage during charging and discharging the battery modules 100, and the control unit 520 may further control and measure other essential parameters such as temperatures of the battery modules and/or battery cells and/or the first heat transfer liquid, for example.

The battery pack 400 of FIG. 5 comprises a protective casing 510 for accommodating the at least one battery module 100. The protective casing 510 has a double shell, wherein the protective casing absorbs forces such as hits and vibrations. The protective casing 510 comprises a heat insulating foam inside the double shell construction, providing an efficient heat insulating thereof. The protective casing 510 is made of plastic, the material being UL94-V0, for example. The protective casing 510 may be made of metal or comprise metal.

Further, the protective casing 510 is configured to be filled with the second heat transfer liquid. For sake of the clarity, said second heat transfer liquid is separated from the first heat transfer liquid because the first heat transfer liquid locates in the said closed loop. When the protective casing 510 is filled by the second heat transfer liquid, the second heat transfer liquid surrounds the busbar assemblies 120 of the battery modules 100. Purpose of the second heat transfer liquid surrounding the said busbar assemblies 120 is to prevent fire to spread in cases of battery cells 110 blasting or causing fire via the second end 114 of the battery cell(s) 110.

According to an embodiment, the above-mentioned couplings connecting the inner space 132 of the battery modules 100 to the inner space 132 of the adjacent battery module 100 or to the pump 410 for forming the closed loop, the said couplings also comprise small openings, whereby the first heat transfer liquid still circulates mostly via the closed loop, but the small openings allow the first heat transfer liquid and the second heat transfer liquid to mix slowly for reducing the first heat transfer liquid to be added in maintenance, for example.

According to an embodiment, the battery pack 400 comprises an external heat exchanger for the first heat transfer liquid, wherein the external heat exchanger is coupled to the closed loop. The external heat exchanger is configured to release the heat from the first heat transfer liquid to surrounding structures or spaces of the heat exchanger while the first heat transfer liquid circulates through the external heat exchanger.

It will be obvious to a person skilled in the art that, as the technology advances, the inventive concept can be implemented in various ways. The invention and its embodiments are not limited to the examples described above but may vary within the scope of the claims.

1. A battery module comprising
a plurality of battery cells,
a busbar assembly configured to electrically couple the battery cells,
a housing having an inner space and the plurality of battery cells being arranged in the inner space wherein the inner space of the housing is filled with a first heat transfer liquid,
a plurality of recesses in the inner space of the housing, the battery cells being arranged towards the recesses, wherein the recess has rotationally asymmetric shape relative to a central axis of the corresponding battery cell, and
a filler arranged in the recess and attached to the battery cell, whereby the recess prevents the filler and the battery cell being rotated by the rotationally asymmetric shape of the recess.

2. The battery module (100) as claimed in claim 1, wherein the recess locates below the corresponding battery cell and/or between the corresponding battery cells.

3. The battery module as claimed in claim 1, wherein the battery module further comprises at least one heat unit configured to heat the first heat transfer liquid for heating the plurality of the battery cells.

4. The battery module as claimed in claim 3, wherein the at least one heat unit comprises an elongated heating plate for forming a slalom path for the first heat transfer liquid in the inner space of the housing.

5. The battery module as claimed in claim 1, wherein the housing is made of plastic.

6. The battery module as claimed in claim 1, wherein there are gaps between the battery cells allowing the first heat transfer liquid to flow through the gaps.

7. The battery module as claimed in claim 1, wherein the housing comprises
a lower housing having a plurality of sockets supporting a side portion of the battery cells nearby a first end of the battery cell, wherein the recesses locate at a bottom of the sockets and/or at a wall of the sockets, and
an upper housing having a plurality of sockets supporting the side portion of the battery cells nearby a second end of the battery cell.

8. The battery module as claimed in claim 1, wherein the housing comprises
a lower housing having a plurality of sockets supporting a side portion of the battery cells nearby a first end of the battery cell, wherein the recesses locate at a bottom of the sockets, and
an upper housing having a plurality of sockets supporting the side portion of the battery cells nearby a second end of the battery cell.

9. The battery module as claimed in claim 1, wherein the housing comprises
a lower housing having a plurality of sockets supporting a side portion of the battery cells nearby a first end of the battery cell, wherein the recesses locate at a wall of the sockets and
an upper housing having a plurality of sockets supporting the side portion of the battery cells nearby a second end of the battery cell.

10. A battery pack comprising at least one battery module as claimed in claim 1.

11. The battery pack as claimed in claim 10, wherein the battery pack comprises a pump and a closed loop via the pump and the at least one battery module and wherein the pump is configured to circulate the first heat transfer liquid through the at least one battery module.

12. The battery pack as claimed in claim 10, wherein the battery pack further comprises a protective casing for accommodating the at least one battery module.

13. The battery pack as claimed in claim 12, wherein the protective casing is filled by a second heat transfer liquid, whereby the at least one busbar assembly is surrounded by the second heat transfer liquid.

14. The battery pack as claimed in claim 10, wherein the battery pack further comprises a control unit for controlling current and voltage during charging or discharging of the battery pack.

15. An electric vehicle comprising at least one battery pack as claimed in claim 10.

16. A housing for a battery module the housing being made of plastic, wherein the housing comprises
an inner space for receiving battery cells,
a plurality of sockets substantially preventing the battery cells to move in a lateral direction of the corresponding battery cells, and
a plurality of the recesses in the inner space of the housing, wherein in the recesses there is a space for being filled by a filler and wherein each recess has a rotationally asymmetric shape relative to a central axis of the corresponding battery cell.

17. The housing as claimed in claim 16, wherein the recesses locate at a bottom of the sockets and/or at a wall of the sockets.

18. The housing as claimed in claim 16, wherein the recesses locate at a bottom of the sockets.

19. The housing as claimed in claim 16, wherein the recesses (140) locate at a wall of the sockets.

20. The housing as claimed in claim 16, wherein the housing comprises
a lower housing for supporting the side portion of each battery cell nearby the first end of each battery cell, wherein the lower housing has the plurality of sockets, and wherein a wall of the socket is against the side portion of the battery cell with a certain tolerance substantially preventing the lateral movement of the battery cell, and
an upper housing for supporting the side portion of each battery cell nearby the second end of each battery cell, wherein the upper housing has a plurality of sockets for the second end of each battery cell being in the corresponding socket, and wherein a wall of the socket is against the side portion of the battery cell with a certain tolerance substantially preventing the lateral movement of the battery cell, wherein
the recesses locate at a bottom of the sockets of the lower housing and/or at a wall of the sockets of the lower housing.
